(19) United States
(12) Patent Application Publication
(10) Pub. No.: US 2026/0006415 A1
(43) Pub. Date: Jan. 1, 2026

(54) COMMUNICATION SYSTEM, COMMUNICATION METHOD, AND VEHICLE THAT USES VEHICLE-TO-VEHICLE COMMUNICATION

(71) Applicant: Panasonic Automotive Systems Co., Ltd., Kanagawa (JP)

(72) Inventor: Takashi TOKIZAKI, Kanagawa (JP)

(73) Assignee: Panasonic Automotive Systems Co., Ltd., Kanagawa (JP)

(21) Appl. No.: 19/253,008

(22) Filed: Jun. 27, 2025

(30) Foreign Application Priority Data
Jun. 28, 2024 (JP) 2024-105679

(51) Int. Cl. H04W 4/46; H04W 12/106

(52) U.S. Cl. CPC H04W 4/46; H04W 12/106

(57) ABSTRACT

A server stores data including first data and second data, first information for verifying legitimacy of the first data, and second information for verifying legitimacy of the second data. The server transmits management information and the first data to the first vehicle and transmits the management information and the second data to the second vehicle, the management information including the first information and the second information. The first vehicle receives the management information and the first data from the server, and the second vehicle receives the management information and the second data from the server.

### BACKGROUND

### 1. Field

The present disclosure relates to communication technology and, in particular to a communication system, a communication method, and a vehicle that uses vehicle-to-vehicle communication.

### 2. Description of the Related Art

When a plurality of vehicles communicate with a management server, one of the plurality of vehicles is defined as a representative node, and the remaining vehicles are defined as non-representative nodes. The management server sends job data to the representative node, and the representative node sends the job data to the non-representative nodes that exist within the communicable range from the representative node. The non-representative node processes the job data without communicating with the management server (see, for example, Patent Literature 1).
[Patent Literature 1] JP2023-48844

By transferring data between a plurality of vehicles by vehicle-to-vehicle communication, the amount of data transmitted from the management server is reduced. Although the non-representative node receives data from the representative node, it is unclear whether the data is from the management server transferred by the representative node or data tampered with at the representative node. In other words, the non-representative node cannot ensure the legitimacy of the data.

### SUMMARY

The present disclosure addresses the issue described above, and a purpose thereof is to provide a technology that ensures the legitimacy of data while reducing the amount of communication from the server at the same time.

A communication system according to an embodiment of the present disclosure includes: a server that stores data including first data and second data, first information for verifying legitimacy of the first data, and second information for verifying legitimacy of the second data; and a first vehicle and a second vehicle adapted to communicate with the server. The server transmits management information and the first data to the first vehicle and transmits the management information and the second data to the second vehicle, the management information including the first information and the second information, the first vehicle receives the management information and the first data from the server, the second vehicle receives the management information and the second data from the server, the first vehicle transmits the first data to the second vehicle, and the second vehicle receives the first data from the first vehicle and then verifies legitimacy of the first data by referring to the first information included in the management information.

Another embodiment of the present disclosure also relates to a communication system. The communication system includes: a first vehicle that retains data including first data and second data; a server that stores first information for verifying legitimacy of the first data and second information for verifying legitimacy of the second data; and a second vehicle adapted to communicate with the first vehicle and the server. The server transmits management information including the first information and the second information to the second vehicle, the second vehicle receives the management information from the server, the first vehicle transmits the first data to the second vehicle, and the second vehicle receives the first data from the first vehicle and then verifies legitimacy of the first data by referring to the first information included in the management information.

Still another embodiment of the present disclosure relates to a communication method. The communication method is a communication method in a server and in a first vehicle and a second vehicle adapted to communicate with the server, the server storing data including first data and second data, first information for verifying legitimacy of the first data, and second information for verifying legitimacy of the second data, including: transmitting, by the server, management information and the first data to the first vehicle and transmitting the management information and the second data to the second vehicle, the management information including the first information and the second information, receiving, by the first vehicle, the management information and the first data from the server, receiving, by the second vehicle, the management information and the second data from the server, transmitting, by the first vehicle, the first data to the second vehicle, and receiving, by the second vehicle, the first data from the first vehicle and then verifying legitimacy of the first data by referring to the first information included in the management information.

Still another embodiment of the present disclosure also relates to a communication method. The method is a communication method in a first vehicle, a second vehicle, and a server, the first vehicle retaining data including first data and second data; the server storing first information for verifying legitimacy of the first data and second information for verifying legitimacy of the second data, and the second vehicle being adapted to communicate with the first vehicle and the server, including: transmitting, by the server, management information including the first information and the second information to the second vehicle, receiving, by the second vehicle, the management information from the server, transmitting, by the first vehicle, the first data to the second vehicle, and receiving, by the second vehicle, the first data from the first vehicle and then verifying legitimacy of the first data by referring to the first information included in the management information.

Still another embodiment of the present disclosure relates to a vehicle. The vehicle includes: a first communication unit that receives, from a server that stores data including first data and second data, first information for verifying legitimacy of the first data, and second information for verifying legitimacy of the second data, management information and the second data, the management information including the first information and the second information; a second communication unit that receives the first data from a further vehicle that receives the management information and the first data from the server; and a processing unit that verifies legitimacy of the first data received by the second communication unit by referring to the first information included in the management information received by the first communication unit.

Still another embodiment of the present disclosure relates to a vehicle. The vehicle includes: a first communication unit that receives, from a server that stores first information for verifying legitimacy of first data and second information for verifying legitimacy of second data, management information including the first information and the second information; a second communication unit that receives the first data from a further vehicle that stores data including the first data and the second data; and a processing unit that verifies legitimacy of the first data received by the second communication unit by referring to the first information included in the management information received by the first communication unit.

Optional combinations of the aforementioned constituting elements, and implementations of the invention in the form of methods, apparatuses, systems, recording mediums, and computer programs may also be practiced as additional modes of the present invention.

### BRIEF DESCRIPTION OF THE DRAWINGS

FIG. 1 shows a configuration of a communication system according to exemplary embodiment 1;

FIGS. 2A-2C show a data format of signals transmitted from the server of FIG. 1;

FIG. 3 shows a configuration of the vehicle of FIG. 1;

FIG. 4 is a sequence chart showing the steps of communication performed by the communication system according to exemplary embodiment 1;

FIG. 5 is a sequence chart showing the steps of the first process performed by the communication system according to exemplary embodiment 1;

FIG. 6 shows a data format of the management information used in the second process in the communication system according to exemplary embodiment 1;

FIG. 7 is a sequence chart showing the steps of the second process performed by the communication system according to exemplary embodiment 1;

FIG. 8 is a sequence chart showing the steps of the third process performed by the communication system according to exemplary embodiment 1;

FIG. 9 is a sequence chart showing the steps of the fourth process performed by the communication system according to exemplary embodiment 1;

FIG. 10 is a sequence chart showing the steps of the fifth process performed by the communication system according to exemplary embodiment 1;

FIG. 11 is a sequence chart showing the steps of the sixth process performed by the communication system according to exemplary embodiment 1;

FIG. 12 is a sequence chart showing the steps of the seventh process performed by the communication system according to exemplary embodiment 1;

FIG. 13 is a sequence chart showing the steps of the eighth process performed by the communication system according to exemplary embodiment 1;

FIG. 14 is a sequence chart showing the steps of the ninth process performed by the communication system according to exemplary embodiment 1;

FIG. 15 is a sequence chart showing the steps of the tenth process performed by the communication system according to exemplary embodiment 1;

FIG. 16 shows a data format of the signal transmitted from the server according to exemplary embodiment 2; and

FIG. 17 is a sequence chart showing the steps of communication performed by the communication system according to exemplary embodiment 2.

### DETAILED DESCRIPTION

The invention will now be described by reference to the preferred embodiments. This does not intend to limit the scope of the present invention, but to exemplify the invention.

### Exemplary Embodiment 1

A brief summary will be given before describing the present disclosure in specific details. Exemplary embodiment 1 of the present disclosure relates to a communication system that performs wireless communication between a plurality of vehicles and a server. The communication system is used for, for example, OTA (Over The Air). OTA is a technology for transmitting and receiving data between a server and a vehicle via wireless communication to update vehicle software or firmware. Since vehicles are located in various places, a public network such as a mobile phone communication network is used to transmit data from the server to the vehicle. Since the communication fee of the public network depends on the amount of communication, it is necessary to reduce the amount of communication from the server to the vehicle.

To reduce the amount of communication from the server to the vehicle in this exemplary embodiment, update data is divided into a plurality of pieces, and each of the plurality of vehicles is included in one of groups defined such that the number of groups is equal to the number of divisions of the update data. When the number of divisions is “3”, for example, the update data is divided into the first data through the third data, and each vehicle is included in one of the first through third groups. The first through third data are collectively referred to as divided data.

The server transmits the first data to each vehicle included in the first group but does not transmit the second data and the third data. The server transmits the second data to each vehicle included in the second group but does not transmit the first data and the third data. The server transmits the third data to each vehicle included in the third group but does not transmit the first data and the second data. As a result, the amount of data transmitted from the server to the vehicle will be about “⅓”.

Each vehicle is capable of vehicle-to-vehicle communication and is movable. With the elapse of time, therefore, each vehicle will be able to communicate with vehicles of other groups. The first through third data are exchanged as each vehicle performs vehicle-to-vehicle communication with vehicles of other groups. Finally, each vehicle acquires the update data by acquiring the first data through the third data.

It will be noted here that, since the vehicle does not receive update data directly from the server, the legitimacy of the divided data received from other vehicles cannot be ensured. To ensure the legitimacy of the divided data, the first information for verifying the legitimacy of the first data, the second information for verifying the legitimacy of the second data, and the third information for verifying the legitimacy of the third data are aggregated in management information, and the server transmits the management information to all vehicles. The vehicle uses the management information received from the server to verify the legitimacy of the divided data received from other vehicles. The vehicle collects all divided data for which the legitimacy has been verified and then executes a software update with the update data.

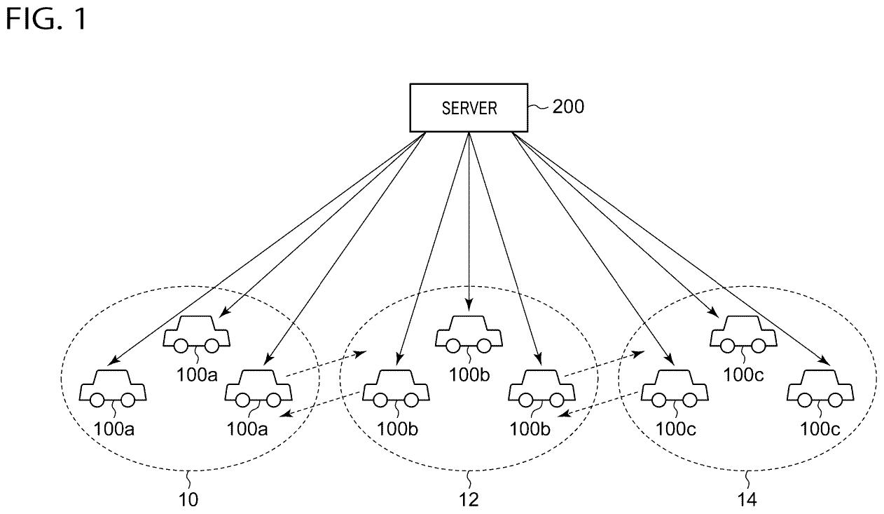

FIG. 1 shows a configuration of a communication system 1000. The communication system 1000 includes a first vehicle 100a, a second vehicle 100b, a third vehicle 100c, collectively referred to as the vehicle 100, and a server 200. A first group 10, a second group 12, and a third group 3 are defined. The number of groups is not limited to “3”. The first group 10 includes a plurality of first vehicles 100a, the second group 12 includes a plurality of second vehicles 100b, and the third group 14 includes a plurality of third vehicles 100c. The classification of the vehicle 100 into the first group 10 through the third group 14 is made according to, for example, the region in which the vehicle 100 is registered. In that process, the first group 10 will include the first vehicle 100a registered in Tokyo, the second group 12 will include the second vehicle 100b registered in Kanagawa Prefecture, and the third group 14 will include the third vehicle 100c registered in Saitama Prefecture. The classification of the vehicle 100 into the first group 10 through the third group 14 may be made according to the vehicle number.

Each vehicle 100 can communicate with the server 200 by wireless communication on the public network. The public network is, for example, a mobile phone communication network such as a 4G communication network and a 5G communication network. The vehicle 100 may communicate with a communication apparatus (not shown) by wireless LAN (Local Area Network), Bluetooth (registered trademark), and the communication apparatus may communicate with the server 200 by wireless communication on a public network.

The server 200 stores the first data, the second data, and the third data derived from dividing data (update data) into 3. The number of data division is not limited to “3”. Further, the server 200 stores information for verifying the legitimacy of each data, i.e., information that ensures the tampering resistance of each data. For example, the server 200 stores first information for verifying the legitimacy of the first data, second information for verifying the legitimacy of the second data, and third information for verifying the legitimacy of the third data. The first information is a hash value of the first data (hereinafter referred to as a “first hash value”), the second information is a hash value of the second data (hereinafter referred to as a “second hash value”), and the third information is a hash value of the third data (hereinafter referred to as a “third hash value”). The first hash value, the second hash value, and the third hash value are included in the management information.

The server 200 can perform wireless communication on a public network. The server 200 transmits the management information and the first data to each of the plurality of first vehicles 100a included in the first group 10. Further, the server 200 transmits the management information and the second data to each of the plurality of second vehicles 100b included in the second group 12. Further, the server 200 transmits the management information and the third data to each of the plurality of third vehicles 100c included in the third group 14. In other words, the server 200 transmits the management information to all vehicles 100 and transmits a portion of the update data to all vehicles 100. The server 200 stores the address of each first vehicle 100a, the address of each second vehicle 100b, and the address of each third vehicle 100c in advance.

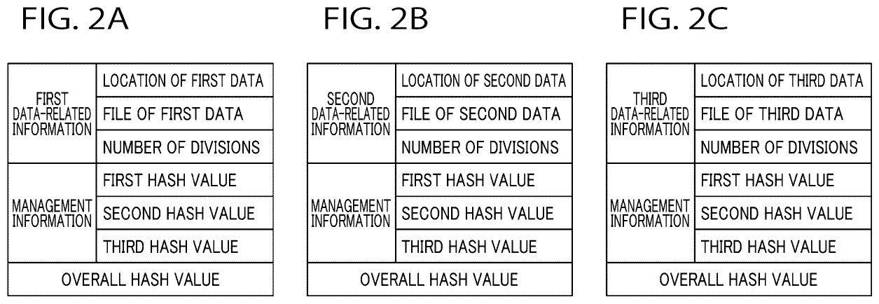

FIGS. 2A-2C show data a format of signals transmitted from the server 200. FIG. 2A shows a signal transmitted to each of the plurality of first vehicles 100a included in the first group 10. The first data-related information includes the “file of the first data”, which embodies the first data, and the “location of the first data” and the “number of divisions”, which are information related to the first data. The location of the first data indicates the address where the first data is stored, and the number of divisions indicates the number of divisions in which the update data is divided. In this exemplary embodiment, the number of divisions is “3”. The management information includes the “first hash value”, the “second hash value”, and the “third hash value”. The overall hash value is a hash value for the first data-related information and the management information.

FIG. 2B shows a signal transmitted to each of the plurality of second vehicles 100b included in the second group 12. The second data-related information includes the “file of the second data”, which embodies the second data, and the “location of the second data” and the “number of divisions”, which are information related to the second data. The location of the second data indicates the location where the second data is stored. In this exemplary embodiment, the number of divisions is “3”. The management information includes the “first hash value”, the “second hash value”, and the “third hash value”. The overall hash value is a hash value for the second data-related information and the management information.

FIG. 2C shows a signal transmitted to each of the plurality of third vehicles 100c included in the third group 14. The third data-related information includes the “file of the third data”, which embodies the third data, and the “location of the third data” and the “number of divisions”, which are information related to the third data. The location of the third data indicates the location where the third data is stored. In this exemplary embodiment, the number of divisions is “3”. The management information includes the “first hash value”, the “second hash value”, and the “third hash value”. The overall hash value is a hash value for the third data-related information and the management information. Reference is made back to FIG. 1.

Each first vehicle 100a receives the first data-related information, the management information, and the overall hash value shown in FIG. 2A from the server 200. Each first vehicle 100a verifies the legitimacy of the first data by referring to the first hash value included in the management information. When the first data is legitimate, the first vehicle 100a retains the first data.

Each second vehicle 100b receives the second data-related information, the management information, and the overall hash value shown in FIG. 2B from the server 200. Each second vehicle 100b verifies the legitimacy of the second data by referring to the second hash value included in the management information. When the second data is legitimate, the second vehicle 100b retains the second data.

Each third vehicle 100c receives the third data-related information, the management information, and the overall hash value shown in FIG. 2C from the server 200. Each third vehicle 100c verifies the legitimacy of the third data by referring to the third hash value included in the management information. When the third data is legitimate, the third vehicle 100c retains the third data.

In other words, the first vehicle 100a retains only the first data and does not retain the second data and the third data immediately after the transmission from the server 200. Further, the second vehicle 100b retains only the second data and does not retain the first data and the third data. Further, the third vehicle 100c retains only the third data and does not retain the first data and the second data.

Since the vehicle 100 is movable, the vehicle moves and passes the vehicle 100 of another group with the elapse of time. For example, the first vehicle 100a passes the second vehicle 100b, the second vehicle 100b passes the third vehicle 100c, and the third vehicle 100c passes the first vehicle 100a. In this process, each vehicle 100 executes vehicle-to-vehicle communication with the other vehicle 100 and exchanges divided data.

When the first vehicle 100a and the second vehicle 100b pass each other, for example, vehicle-to-vehicle communication is executed, the first vehicle 100a transmits the first data-related information to the second vehicle 100b, and the second vehicle 100b receives the first data-related information from the first vehicle 100a. This first data-related information may not include the number of divisions. The second vehicle 100b verifies the legitimacy of the first data by referring to the first hash value included in the related information already retained. When the first data is legitimate, the second vehicle 100b retains the first data.

Further, when the second vehicle 100b and the third vehicle 100c pass each other, vehicle-to-vehicle communication is executed, the third vehicle 100c transmits the third data-related information to the second vehicle 100b, and the second vehicle 100b receives the third data-related information from the third vehicle 100c. The third data-related information may not include the number of divisions. The third vehicle 100c verifies the legitimacy of the third data by referring to the third hash value included in the related information already retained. When the third data is legitimate, the second vehicle 100b retains the third data.

As a result of these processes, the second vehicle 100b retains the first data through the third data. This corresponds to retaining the update data, and the second vehicle 100b executes a software update with the update data. A similar process is performed in the first vehicle 100a and the second vehicle 100b.

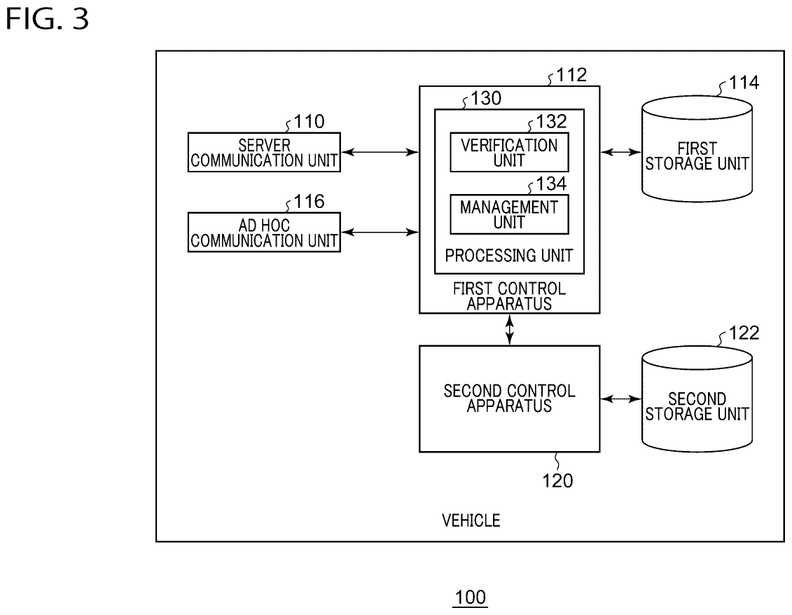

FIG. 3 shows a configuration of the vehicle 100. The vehicle 100 includes a server communication unit 110, a first control apparatus 112, a first storage unit 114, an ad hoc communication unit 116, a second control apparatus 120, and a second storage unit 122. The first control apparatus 112 includes a processing unit 130, and the processing unit 130 includes a verification unit 132 and a management unit 134. It is assumed here that the vehicle 100 is the second vehicle 100b of FIG. 1, but the first vehicle 100a and the third vehicle 100c have a similar configuration.

The server communication unit 110 (first communication unit) can perform wireless communication on a public network and communicates with the server 200 (FIG. 1). As described above, the server communication unit 110 can perform wireless communication of wireless LAN and may communicate with the server 200 via a communication apparatus (not shown). The server communication unit 110 receives the second data-related information, the management information, and the overall hash value from the server 200. The server communication unit 110 outputs the second data-related information, the management information, and the overall hash value to the first control apparatus 112.

The first control apparatus 112 is, for example, a multimedia control apparatus that performs video or audio reproduction. The first control apparatus 112 operates according to the software stored in the first storage unit 114 described later. The software stored in the first storage unit 114 is software to be updated with the update data. That is, the software is subject to OTA.

The verification unit 132 receives the second data-related information, the management information, and the overall hash value from the server communication unit 110. The verification unit 132 verifies the legitimacy of the second data-related information and the management information using the overall hash value. Since a known technology may be used to verify legitimacy, a description thereof is omitted here. When the second data-related information and the management information are legitimate, the verification unit 132 verifies the legitimacy of the second data by referring to the second hash value included in the management information. When the second data is legitimate, the verification unit 132 causes the first storage unit 114 to retain the second data-related information and the management information. When the second data-related information and the management information are not legitimate, or when the second data is not legitimate, on the other hand, the verification unit 132 terminates the process.

The first storage unit 114 is a semiconductor memory, a non-volatile memory, or a storage medium, and can store digital data. Examples of the semiconductor memory include RAM (Random Access Memory), ROM (Read Only Memory), flash memory, SDRAM (Synchronous Dynamic RAM), etc. Examples of the non-volatile memory include EPROM (Erasable Programmable ROM), EEPROM (Electrically Erasable Programmable ROM). The storage media is, for example, SSD (Solid State Drive) or HDD (Hard Disk Drive). The first storage unit 114 stores the second data-related information and the management information.

The ad hoc communication unit 116 (second communication unit) can perform ad hoc vehicle-to-vehicle communication. The ad hoc communication unit 116 communicates with other vehicles 100 such as the first vehicle 100a and the third vehicle 100c by vehicle-to-vehicle communication. The ad hoc communication unit 116 receives the first data-related information from the first vehicle 100a. As described above, this first data-related information may not include the number of divisions. Information to be transmitted and received by vehicle-to-vehicle communication in the ad hoc communication unit 116 is managed by the management unit 134, but the process in the management unit 134 will be described later. The ad hoc communication unit 116 outputs the first data-related information to the first control apparatus 112.

The verification unit 132 receives the first data-related information from the ad hoc communication unit 116. The verification unit 132 verifies the legitimacy of the first data by referring to the first hash value stored in the first storage unit 114. When the first data is legitimate, the verification unit 132 causes the first storage unit 114 to retain the first data-related information. When the first data is not legitimate, on the other hand, the verification unit 132 terminates the process.

The ad hoc communication unit 116 receives the third data-related information from the third vehicle 100c. The ad hoc communication unit 116 outputs the third data-related information to the first control apparatus 112. The verification unit 132 receives the third data-related information from the ad hoc communication unit 116. The verification unit 132 verifies the legitimacy of the third data by referring to the third hash value stored in the first storage unit 114. When the third data is legitimate, the verification unit 132 causes the first storage unit 114 to retain the third data-related information. When the third data is not legitimate, on the other hand, the verification unit 132 terminates the process.

The processing unit 130 confirms that the update data includes the first data through the third data based on the number of divisions stored in the first storage unit 114. Further, when the first data through the third data are stored in the first storage unit 114, the processing unit 130 extracts the first data through the third data from the first storage unit 114 and retrieves the update data by combining the first data through the third data. The processing unit 130 updates the software stored in the first storage unit 114 with the update data.

The ad hoc communication unit 116 may transmit the second data-related information stored in the first storage unit 114 to the other vehicle 100 according to the control by the management unit 134. Further, when the first data-related information or the third data-related information is stored in the first storage unit 114, the ad hoc communication unit 116 may transmit the first data-related information or the third data-related information to the other vehicle 100 according to the control by the management unit 134.

The second control apparatus 120 is an apparatus in the vehicle 100 for controlling a part different from the target of control by the first control apparatus 112. The second control apparatus 120 operates according to the software stored in the second storage unit 122. The software stored in the second storage unit 122 is not updated by the update data. In other words, the software is not subject to OTA. The first control apparatus 112 and the second control apparatus 120 are connected by wired communication such as a dedicated line or a CAN (Controller Area Network). The vehicle 100 may further include a control apparatus and a storage unit subject to the OTA and may further include a control apparatus and a storage unit that is not subject to OTA.

The features are implemented in hardware such as a central processing unit (CPU), a memory, or other large scale integration (LSI) of an arbitrary computer and in software such as a program loaded into a memory. The figure depicts functional blocks implemented by the cooperation of these elements. Therefore, it will be understood by those skilled in the art that the functional blocks may be implemented in a variety of manners by hardware only or by a combination of hardware and software.

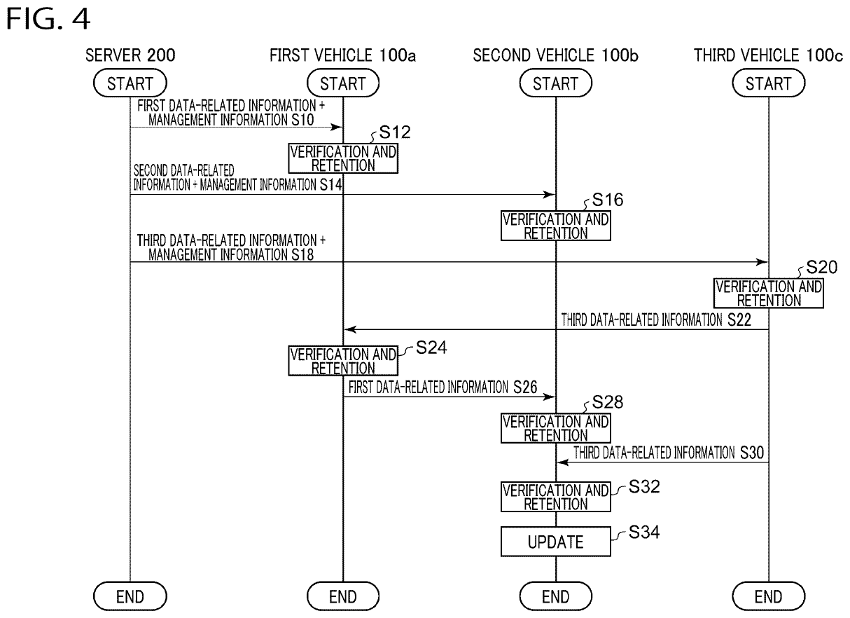

The operation of the communication system 1000 according to the above configuration will be described. FIG. 4 is a sequence chart showing the steps of communication performed by the communication system 1000. In the following, the overall hash value is omitted. The server 200 transmits the first data-related information and the management information to the first vehicle 100a (S10). The first vehicle 100a performs verification and retention of the first data-related information and the management information received (S12). The server 200 transmits the second data-related information and the management information to the second vehicle 100b (S14). The second vehicle 100b performs verification and retention of the second data-related information and the management information received (S16). The server 200 transmits the third data-related information and the management information to the third vehicle 100c (S18). The third vehicle 100c performs verification and retention of the third data-related information and the management information received (S20).

When the first vehicle 100a and the third vehicle 100c approach each other, the third vehicle 100c transmits the third data-related information to the first vehicle 100a (S22). The first vehicle 100a performs verification and retention of the third data-related information received (S24). When the first vehicle 100a and the second vehicle 100b approach each other, the first vehicle 100a transmits the first data-related information to the second vehicle 100b (S26). The second vehicle 100b performs verification and retention of the first data-related information received (S28).

When the second vehicle 100b and the third vehicle 100c approach each other, the third vehicle 100c transmits the third data-related information to the second vehicle 100b (S30). The second vehicle 100b performs verification and retention of the third data-related information received (S32). The second vehicle 100b aggregates the first data through the third data to form the update data and updates the software with the update data (S34).

Hereinafter, the vehicle-to-vehicle communication in such a process, in particular, the vehicle-to-vehicle communication steps between the first vehicle 100a and the second vehicle 100b, will be described as the first through ninth processes. For the purpose of description, the first vehicle 100a is defined as the transmitting side, and the second vehicle 100b is defined as the receiving side. Further, the step of communication between the second vehicle 100b and the server 200 will be described as the tenth process.

### (First Process)

When the second vehicle 100b approaches the first vehicle 100a, the ad hoc communication unit 116 of the second vehicle 100b recognizes that vehicle-to-vehicle communication with the first vehicle 100a is possible by receiving a signal from the first vehicle 100a. The management unit 134 recognizes that the first data and the third data are missing based on the number of divisions “3” in the management information stored in the first storage unit 114 and on the second data stored in the first storage unit 114. The management unit 134 selects one of the first data and the third data (e.g., the first data). The management unit 134 generates a signal for requesting the transmission of the first data that is missing (hereinafter referred to as a “missing data transmission request”). The ad hoc communication unit 116 requests the first vehicle 100a to transmit the first data by transmitting the missing data transmission request to the first vehicle 100a.

The ad hoc communication unit 116 of the first vehicle 100a receives the missing data transmission request from the second vehicle 100b. The management unit 134 recognizes the transmission of the first data based on the missing data transmission request and extracts the first data-related information from the first storage unit 114. The ad hoc communication unit 116 transmits the first data-related information to the second vehicle 100b as missing data-related information.

The ad hoc communication unit 116 of the second vehicle 100b receives the missing data-related information from the first vehicle 100a. The ad hoc communication unit 116 outputs the first data-related information, which is the missing data-related information, to the first control apparatus 112. The verification unit 132 receives the first data-related information from the ad hoc communication unit 116. The verification unit 132 verifies the legitimacy of the first data by referring to the first hash value stored in the first storage unit 114. When the first data is legitimate, the verification unit 132 causes the first storage unit 114 to retain the first data-related information.

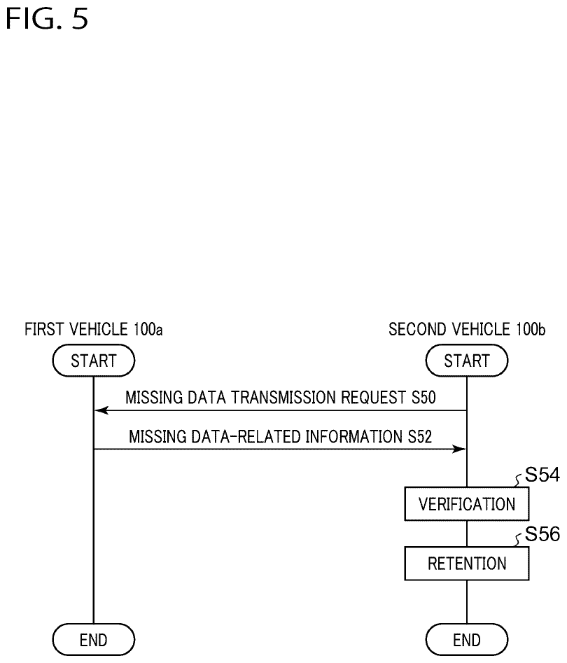

The operation of the communication system 1000 according to the above configuration will be described. FIG. 5 is a sequence chart showing the steps of the first process performed by the communication system 1000. The second vehicle 100b transmits a missing data transmission request to the first vehicle 100a (S50). The first vehicle 100a transmits the missing data-related information to the second vehicle 100b in response to the missing data transmission request received (S52). The second vehicle 100b verifies the legitimacy of the missing data-related information received (S54) and retains the missing data-related information (S56).

### (Second Process)

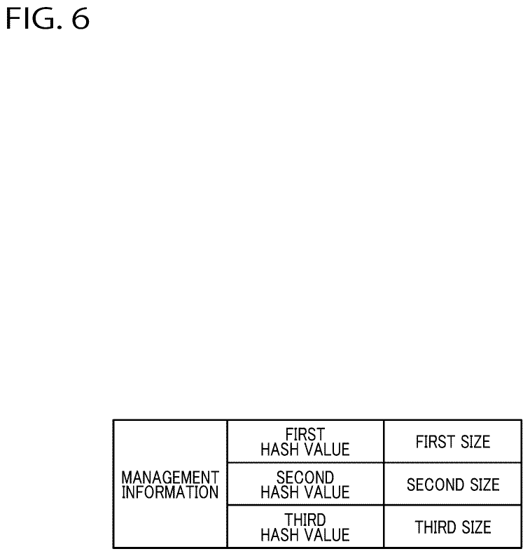

The management information may include the size of the first data, the size of the second data, and the size of the third data. FIG. 6 shows a data format of the management information used in the second process in the communication system 1000. As shown, the management information includes the “first size” which is the size of the first data, the “second size” which is the size of the second data, and the “third size” which is the size of the third data.

When the second vehicle 100b approaches the first vehicle 100a, the ad hoc communication unit 116 of the second vehicle 100b recognizes that vehicle-to-vehicle communication with the first vehicle 100a is possible by receiving a signal from the first vehicle 100a. The management unit 134 recognizes that the first data and the third data are missing based on the number of divisions “3” in the management information stored in the first storage unit 114 and on the second data stored in the first storage unit 114.

The management unit 134 acquires the speed of the second vehicle 100b from the speed sensor provided in the second vehicle 100b. The management unit 134 stores in advance the correspondence between speed and size defined such that the higher the speed, the smaller the size. The management unit 134 specifies a size (hereinafter referred to as a “target value”) from the acquired speed and the correspondence. Further, the management unit 134 acquires the first size corresponding to the first data and the third size of the third data from the management information. Of the first size and the third size, the management unit 134 selects, as the missing data, the divided data for which the size is smaller than the target value and close to the target value. The management unit 134 selects, for example, the first data.

The management unit 134 generates a signal for requesting the transmission of the first data that is missing (hereinafter referred to as a “missing data transmission request”). The ad hoc communication unit 116 requests the first vehicle 100a to transmit the first data by transmitting the missing data transmission request to the first vehicle 100a. Since the subsequent process is the same as the first process, a description thereof is omitted here.

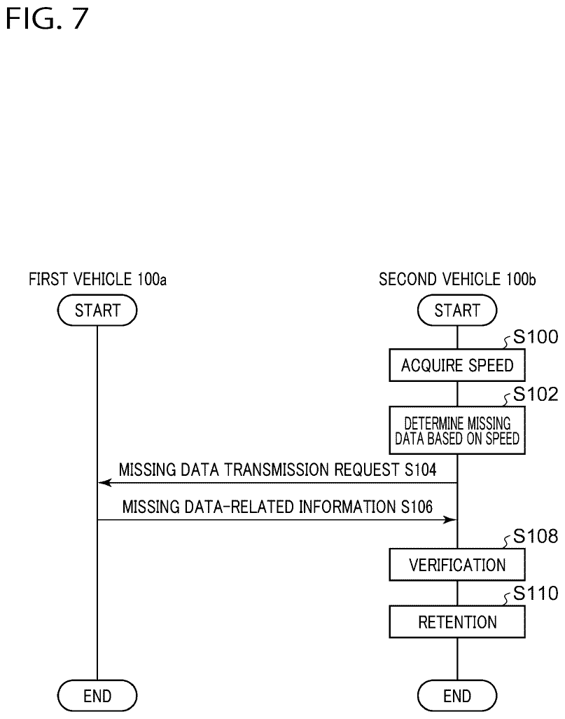

The operation of the communication system 1000 according to the above configuration will be described. FIG. 7 is a sequence chart showing the steps of the second process performed by the communication system 1000. The second vehicle 100b acquires the speed of the second vehicle 100b (S100). The second vehicle 100b determines the missing data based on the speed (S102). The second vehicle 100b transmits a missing data transmission request to the first vehicle 100a (S104). The first vehicle 100a transmits the missing data-related information to the second vehicle 100b in response to the missing data transmission request received (S106). The second vehicle 100b verifies the legitimacy of the missing data-related information received (S108) and retains the missing data-related information (S110).

### (Third Process)

When the second vehicle 100b approaches the first vehicle 100a, the ad hoc communication unit 116 of the second vehicle 100b recognizes that vehicle-to-vehicle communication with the first vehicle 100a is possible by receiving a signal from the first vehicle 100a. The management unit 134 recognizes that the first data and the third data are missing based on the number of divisions “3” in the management information stored in the first storage unit 114 and on the second data stored in the first storage unit 114. The management unit 134 generates a signal for requesting the transmission of either the missing first data or the third data missing (hereinafter referred to as a “missing list transmission request”). The ad hoc communication unit 116 requests the first vehicle 100a to transmit the first data and the third data by transmitting the missing list transmission request to the first vehicle 100a.

The ad hoc communication unit 116 of the first vehicle 100a receives the missing list transmission request from the second vehicle 100b. Of the first data and the third data, the management unit 134 determines the transmission of the first based on the missing list transmission request and extracts the first data-related information from the first storage unit 114. The ad hoc communication unit 116 transmits the first data-related information to the second vehicle 100b as the missing data-related information. Since the subsequent process is the same as the first process, a description is omitted here.

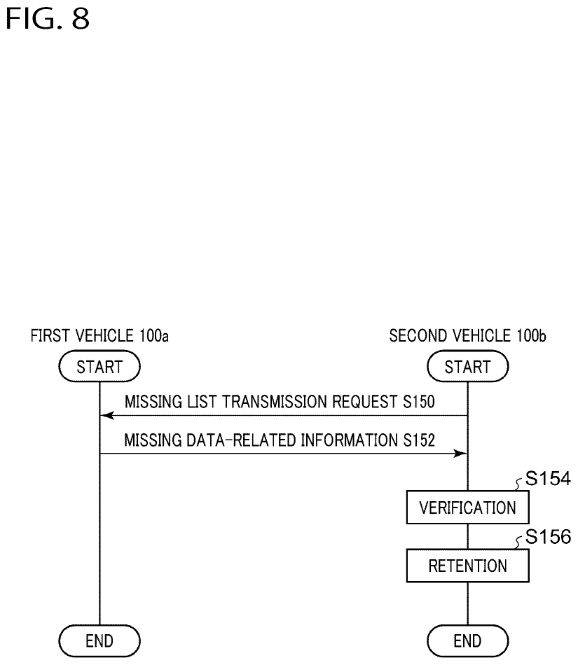

The operation of the communication system 1000 according to the above configuration will be described. FIG. 8 is a sequence chart showing the steps of the third process performed by the communication system 1000. The second vehicle 100b transmits the missing list transmission request to the first vehicle 100a (S150). The first vehicle 100a transmits the missing data-related information to the second vehicle 100b in response to the missing list transmission request received (S152). The second vehicle 100b verifies the legitimacy of the missing data-related information received (S154) and retains the missing data-related information (S156).

### (Fourth Process)

The management information in the fourth process is as shown in FIG. 6. When the second vehicle 100b approaches the first vehicle 100a, the ad hoc communication unit 116 of the second vehicle 100b recognizes that vehicle-to-vehicle communication with the first vehicle 100a is possible by receiving a signal from the first vehicle 100a. The management unit 134 recognizes that the first data and the third data are missing based on the number of divisions “3” in the management information stored in the first storage unit 114 and on the second data stored in the first storage unit 114. The management unit 134 generates a signal for requesting the transmission of either the first data or the third data that is missing (hereinafter referred to as a “missing list transmission request”). The ad hoc communication unit 116 requests the first vehicle 100a to transmit the first data and the third data by transmitting the missing list transmission request to the first vehicle 100a.

The ad hoc communication unit 116 of the first vehicle 100a receives the missing list transmission request from the second vehicle 100b. The management unit 134 acquires the speed of the first vehicle 100a from the speed sensor provided in the first vehicle 100a. The management unit 134 stores in advance the correspondence between speed and size defined such that the higher the speed, the smaller the size. The management unit 134 specifies a target value from the acquired speed and the correspondence. Further, the management unit 134 acquires the first size corresponding to the first data and the third size of the third data from the management information. Of the first size and the third size, the management unit 134 selects, as the missing data, the divided data for which the size is smaller than the target value and close to the target value. The management unit 134 selects, for example, the first data. The management unit 134 extracts the first data-related information from the first storage unit 114. The ad hoc communication unit 116 transmits the first data-related information to the second vehicle 100b as the missing data-related information. Since the subsequent process is the same as the third process, a description thereof is omitted here.

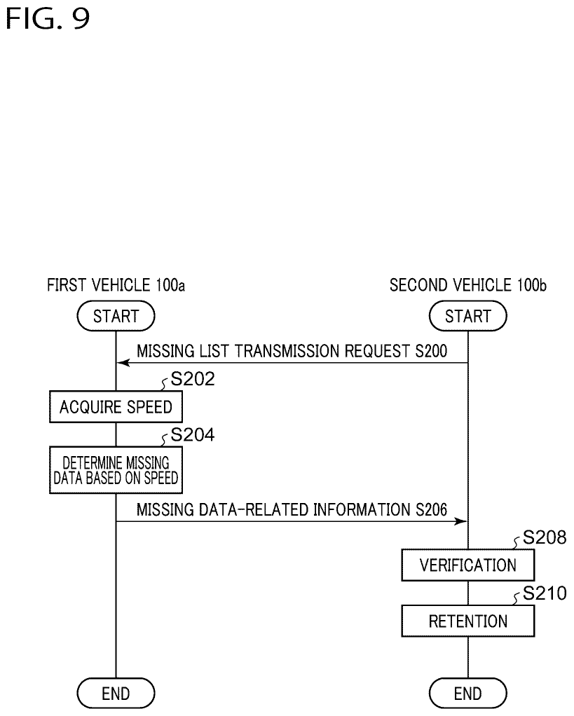

The operation of the communication system 1000 according to the above configuration will be described. FIG. 9 is a sequence chart showing the steps of the fourth process performed by the communication system 1000. The second vehicle 100b transmits the missing list transmission request to the first vehicle 100a (S200). The first vehicle 100a acquires the speed of the first vehicle 100a (S202). The first vehicle 100a determines the missing data based on the speed (S204). The first vehicle 100a transmits the missing data-related information to the second vehicle 100b (S206). The second vehicle 100b verifies the legitimacy of the missing data-related information received (S208) and retains the missing data-related information (S210).

### (Fifth Process)

The management information in the fifth process is as shown in FIG. 6. When the second vehicle 100b approaches the first vehicle 100a, the ad hoc communication unit 116 of the second vehicle 100b recognizes that vehicle-to-vehicle communication with the first vehicle 100a is possible by receiving a signal from the first vehicle 100a. The management unit 134 recognizes that the first data and the third data are missing based on the number of divisions “3” in the management information stored in the first storage unit 114 and on the second data stored in the first storage unit 114.

The management unit 134 acquires the speed of the second vehicle 100b from the speed sensor provided in the second vehicle 100b. The management unit 134 stores in advance the correspondence between speed and size defined such that the higher the speed, the smaller the size. The management unit 134 specifies a target value from the acquired speed and the correspondence. Further, the management unit 134 acquires the first size corresponding to the first data and the third size of the third data from the management information. Of the first size and the third size, the management unit 134 selects the divided data for which the size is smaller than the target value. Multiple pieces of divided data may be selected. The management unit 134 selects, for example, the first data and the third data.

The management unit 134 generates a signal for requesting the transmission of either the first data or the third data that is missing (hereinafter referred to as a “missing list transmission request”). The ad hoc communication unit 116 requests the first vehicle 100a to transmit the first data and the third data by transmitting the missing list transmission request to the first vehicle 100a. Since the subsequent process is the same as the third process, a description thereof is omitted here.

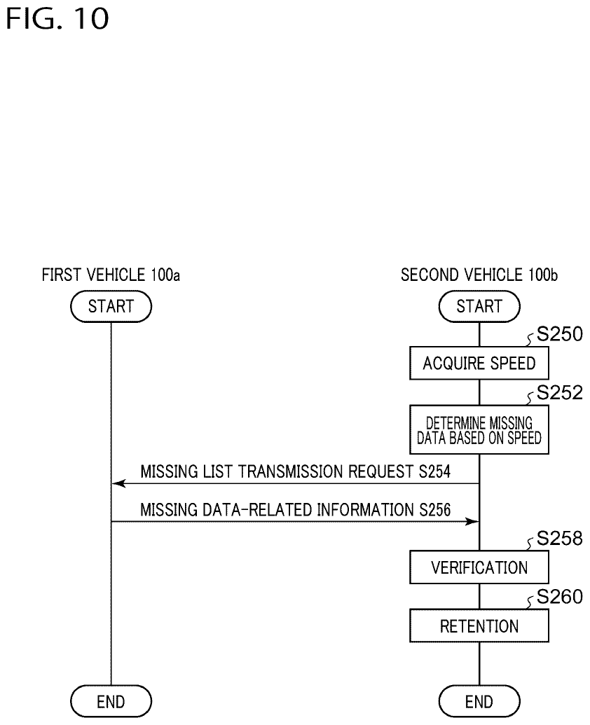

The operation of the communication system 1000 according to the above configuration will be described. FIG. 10 is a sequence chart showing the steps of the fifth process performed by the communication system 1000. The second vehicle 100b acquires the speed of the second vehicle 100b (S250). The second vehicle 100b determines the missing data based on the speed (S252). The second vehicle 100b transmits a missing list transmission request to the first vehicle 100a (S254). The first vehicle 100a transmits the missing data-related information to the second vehicle 100b in response to the missing list transmission request received (S256). The second vehicle 100b verifies the legitimacy of the missing data-related information received (S258) and retains the missing data-related information (S260).

### (Sixth Process)

When the second vehicle 100b approaches the first vehicle 100a, the ad hoc communication unit 116 of the second vehicle 100b recognizes that vehicle-to-vehicle communication with the first vehicle 100a is possible by receiving a signal from the first vehicle 100a. The management unit 134 recognizes that the first data and the third data are missing based on the number of divisions “3” in the management information stored in the first storage unit 114 and on the second data stored in the first storage unit 114. The management unit 134 generates a signal (hereinafter referred to as a “retained data transmission request”) for requesting the transmission of the data retained by the first vehicle 100a. The ad hoc communication unit 116 requests the first vehicle 100a to transmit the first data and the third data by transmitting the retained data transmission request to the first vehicle 100a.

The ad hoc communication unit 116 of the first vehicle 100a receives the retained data transmission request from the second vehicle 100b. The management unit 134 extracts the first data-related information and the third data-related information from the first storage unit 114 based on the retained data transmission request. The first data-related information and the third data-related information represent the data retained by the first vehicle 100a. The ad hoc communication unit 116 transmits the first data-related information and the third data-related information to the second vehicle 100b as retained data-related information.

The ad hoc communication unit 116 of the second vehicle 100b receives the retained data-related information from the first vehicle 100a. The ad hoc communication unit 116 outputs the first data-related information and the third data-related information, which are the retained data-related information, to the first control apparatus 112. The management unit 134 confirms whether the first data-related information and the third data-related information are already retained. When the first data-related information is not retained, the verification unit 132 verifies the legitimacy of the first data by referring to the first hash value stored in the first storage unit 114. When the first data is legitimate, the verification unit 132 causes the first storage unit 114 to retain the first data-related information. When the third data-related information is not retained, the verification unit 132 verifies the legitimacy of the third data by referring to the third hash value stored in the first storage unit 114. When the third data is legitimate, the verification unit 132 causes the first storage unit 114 to retain the third data-related information.

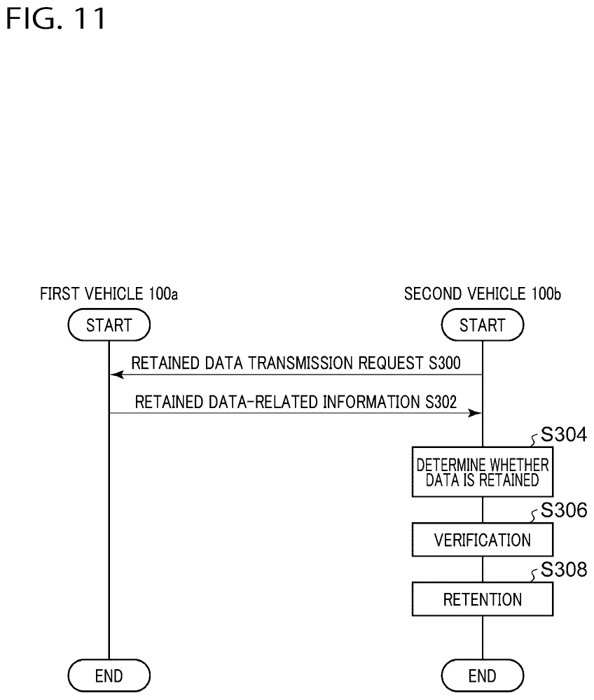

The operation of the communication system 1000 according to the above configuration will be described. FIG. 11 is a sequence chart showing the steps of the sixth process performed by the communication system 1000. The second vehicle 100b transmits a retained data transmission request to the first vehicle 100a (S300). The first vehicle 100a transmits the retained data-related information to the second vehicle 100b in response to the retained data transmission request received (S302). The second vehicle 100b confirms whether the received retained data-related information is retained (S304), verifies the legitimacy of the retained data-related information that is not retained (S306), and retains the retained data-related information (S308).

### (Seventh Process)

The management information in the seventh process is as shown in FIG. 6. When the second vehicle 100b approaches the first vehicle 100a, the ad hoc communication unit 116 of the second vehicle 100b recognizes that vehicle-to-vehicle communication with the first vehicle 100a is possible by receiving a signal from the first vehicle 100a. The management unit 134 recognizes that the first data and the third data are missing based on the number of divisions “3” in the management information stored in the first storage unit 114 and on the second data stored in the first storage unit 114. The management unit 134 generates a signal (hereinafter referred to as a “retained data transmission request”) for requesting the transmission of the data retained by the first vehicle 100a. The ad hoc communication unit 116 requests the first vehicle 100a to transmit the first data and the third data by transmitting the retained data transmission request to the first vehicle 100a.

The ad hoc communication unit 116 of the first vehicle 100a receives the retained data transmission request from the second vehicle 100b. The management unit 134 acquires the speed of the first vehicle 100a from the speed sensor provided in the first vehicle 100a. The management unit 134 stores in advance the correspondence between speed and size defined such that the higher the speed, the smaller the size. The management unit 134 specifies a target value from the acquired speed and the correspondence. Further, the management unit 134 acquires the first size corresponding to the first data and the third size of the third data from the management information. Of the first size and the third size, the management unit 134 selects the divided data for which the size is smaller than the target value and close to the target value. The management unit 134 selects, for example, the first data. The management unit 134 extracts the first data-related information from the first storage unit 114. The ad hoc communication unit 116 transmits the first data-related information to the second vehicle 100b as the retained data-related information. Since the subsequent process is the same as the sixth process, a description thereof is omitted here.

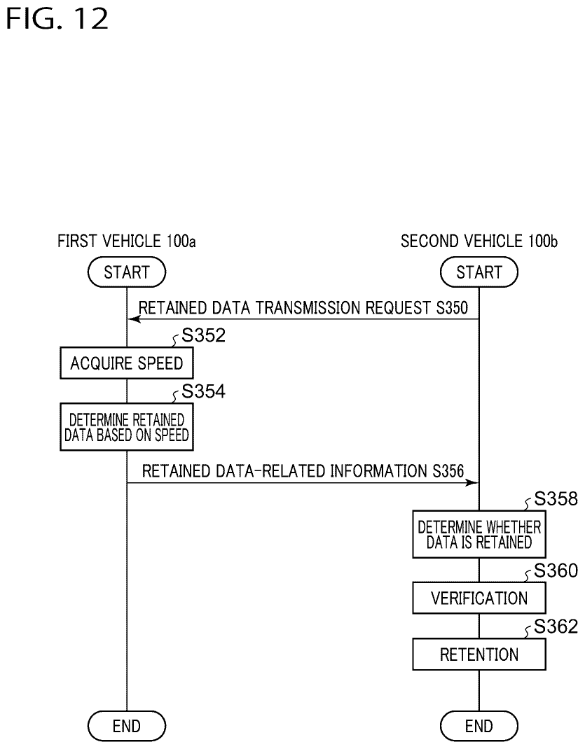

The operation of the communication system 1000 according to the above configuration will be described. FIG. 12 is a sequence chart showing the steps of the seventh process performed by the communication system 1000. The second vehicle 100b transmits a retained data transmission request to the first vehicle 100a (S350). The first vehicle 100a acquires the speed of the first vehicle 100a (S352). The first vehicle 100a determines the retained data based on the speed (S354). The first vehicle 100a transmits the retained data-related information to the second vehicle 100b (S356). The second vehicle 100b confirms whether the retained data-related information received is retained (S358), verifies the legitimacy of the retained data-related information that is not retained (S360), and retains the retained data-related information (S362).

### (Eighth Process)

When the second vehicle 100b approaches the first vehicle 100a, the ad hoc communication unit 116 of the second vehicle 100b recognizes that vehicle-to-vehicle communication with the first vehicle 100a is possible by receiving a signal from the first vehicle 100a. The management unit 134 recognizes that the first data and the third data are missing based on the number of divisions “3” in the management information stored in the first storage unit 114 and on the second data stored in the first storage unit 114.

The ad hoc communication unit 116 of the first vehicle 100a extracts the first data-related information and the third data-related information from the first storage unit 114. The first data-related information and the third data-related information represent the data retained by the first vehicle 100a. The ad hoc communication unit 116 transmits the first data-related information and the third data-related information to the second vehicle 100b as the retained data-related information. Since the subsequent process is the same as the sixth process, a description thereof is omitted here.

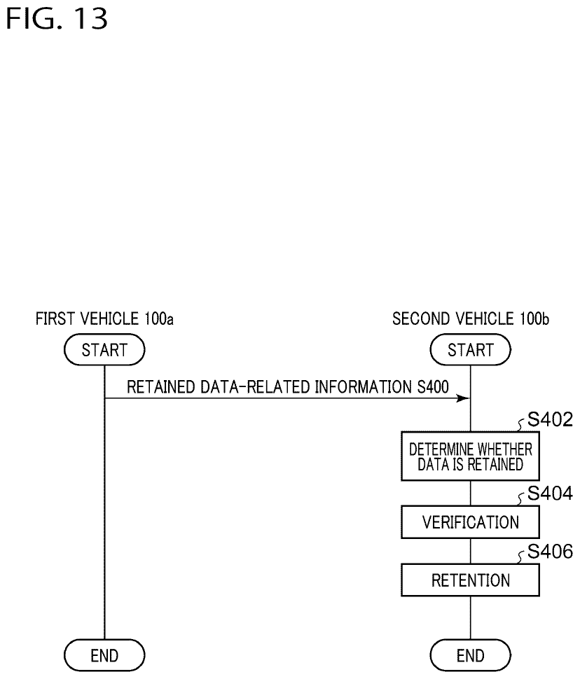

The operation of the communication system 1000 according to the above configuration will be described. FIG. 13 is a sequence chart showing the steps of the eighth process performed by the communication system 1000. The first vehicle 100a transmits the retained data-related information to the second vehicle 100b (S400). The second vehicle 100b confirms whether the retained data-related information received is retained (S402), verifies the legitimacy of the retained data-related information that is not retained (S404), and retains the retained data-related information (S406).

### (Ninth Process)

The management information in the ninth process is as shown in FIG. 6. When the second vehicle 100b approaches the first vehicle 100a, the ad hoc communication unit 116 of the second vehicle 100b recognizes that vehicle-to-vehicle communication with the first vehicle 100a is possible by receiving a signal from the first vehicle 100a. The management unit 134 recognizes that the first data and the third data are missing based on the number of divisions “3” in the management information stored in the first storage unit 114 and on the second data stored in the first storage unit 114.

The management unit 134 of the first vehicle 100a acquires the speed of the first vehicle 100a from the speed sensor provided in the first vehicle 100a. The management unit 134 stores in advance the correspondence between speed and size defined such that the higher the speed, the smaller the size. The management unit 134 specifies a target value from the acquired speed and the correspondence. Further, the management unit 134 acquires the first size corresponding to the first data and the third size of the third data from the management information. Of the first size and the third size, the management unit 134 selects the divided data for which the size is smaller than the target value and close to the target value. The management unit 134 selects, for example, the first data. The management unit 134 extracts the first data-related information from the first storage unit 114. The ad hoc communication unit 116 transmits the first data-related information to the second vehicle 100b as the retained data-related information. Since the subsequent process is the same as the eighth process, a description thereof is omitted here.

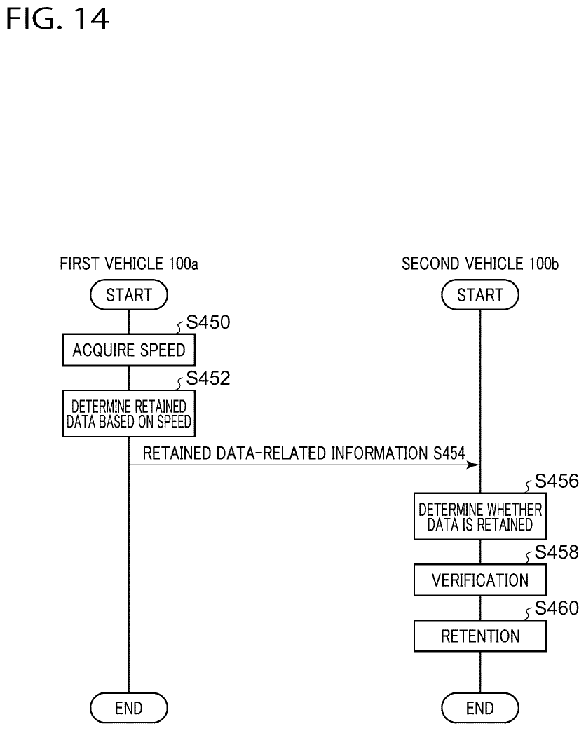

The operation of the communication system 1000 according to the above configuration will be described. FIG. 14 is a sequence chart showing the steps of the ninth process performed by the communication system 1000. The first vehicle 100a acquires the speed of the first vehicle 100a (S450). The first vehicle 100a determines the retained data based on the speed (S452). The first vehicle 100a transmits the retained data-related information to the second vehicle 100b (S454). The second vehicle 100b confirms whether the retained data-related information received is retained (S456), verifies the legitimacy of the retained data-related information that is not retained (S458), and retains the retained data-related information (S460).

### (Tenth Process)

The management information includes an acquisition deadline. When the management unit 134 of the second vehicle 100b fails to acquire the divided data, such as the first data, by the acquisition deadline, the management unit 134 generates a missing data transmission request. The server communication unit 110 transmits the missing data transmission request to the server 200.

The server 200 receives the missing data transmission request from the second vehicle 100b. The server 200 transmits the first data-related information to the second vehicle 100b as the missing data-related information in response to the missing data transmission request received.

The server communication unit 110 of the second vehicle 100b receives the missing data-related information from the server 200. The server communication unit 110 outputs the first data-related information, which is the missing data-related information, to the first control apparatus 112. The verification unit 132 receives the first data-related information from the ad hoc communication unit 116. The verification unit 132 verifies the legitimacy of the first data by referring to the first hash value stored in the first storage unit 114. When the first data is legitimate, the verification unit 132 causes the first storage unit 114 to retain the first data-related information.

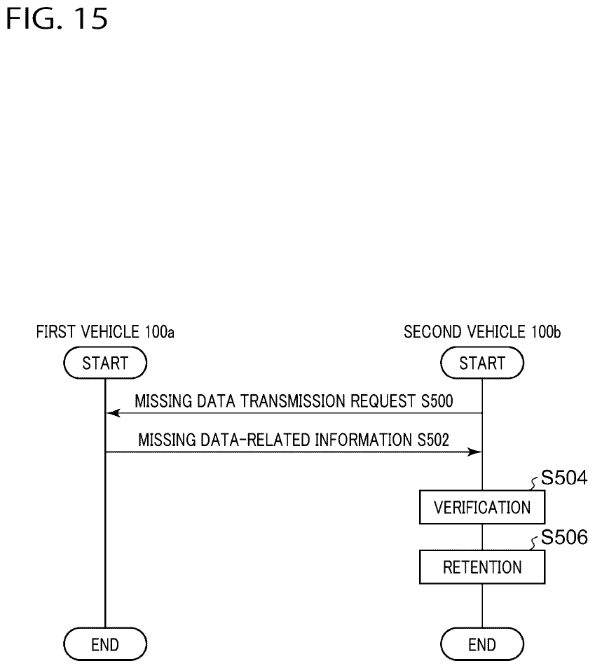

The operation of the communication system 1000 according to the above configuration will be described. FIG. 15 is a sequence chart showing the steps of the tenth process performed by the communication system 1000. The second vehicle 100b transmits a missing data transmission request to the server (S500). The server 200 transmits the missing data-related information to the second vehicle 100b in response to the missing data transmission request received (S502). The second vehicle 100b verifies the legitimacy of the missing data-related information received (S504) and retains the missing data-related information (S506).

According to this exemplary embodiment, one piece of divided data is transmitted and the hash value for verifying the legitimacy of all divided data is concurrently transmitted so that the legitimacy of the data can be ensured while reducing the amount of communication from the server 200 at the same time. Further, the remaining divided data is acquired by vehicle-to-vehicle communication so that the amount of communication from the server 200 can be reduced. Further, the first vehicle 100a transmits data in response to a request from the second vehicle 100b so that the second vehicle 100b can acquire data according to the request. Further, in a situation where the first vehicle 100a transmits data in response to a request from the second vehicle 100b, data corresponding to the speed of the second vehicle 100b is requested so that the size of the data can be increased while improving the success rate of communication at the same time.

Further, in a situation where the first vehicle 100a transmits data in response to a request from the second vehicle 100b, a plurality of pieces of data are requested so that a failure of the first vehicle 100a to transmit data can be suppressed. Further, in a situation where the first vehicle 100a transmits data in response to a request from the second vehicle 100b, a plurality of pieces of data are requested, and data corresponding to the speed of the first vehicle 100a is transmitted so that the size of the data can be increased while improving the success rate of communication at the same time. Further, in a situation where the first vehicle 100a transmits data in response to a request from the second vehicle 100b, the transmission of data retained by the first vehicle 100a is requested so that the request can be simplified. Further, in a situation where the first vehicle 100a transmits data in response to a request from the second vehicle 100b, the transmission of data retained by the first vehicle 100a is requested, and data corresponding to the speed of the first vehicle 100a is transmitted so that the size of the data can be increased while improving the success rate of communication at the same time.

Further, the first vehicle 100a transmits data in the absence of a request from the second vehicle 100b so that the communication steps can be simplified. Further, in a situation where the first vehicle 100a transmits data in the absence of request from the second vehicle 100b, data corresponding to the speed of the first vehicle 100a is transmitted so that the size of the data can be increased while improving the success rate of communication at the same time. Further, data is received from the server 200 when data cannot be acquired by the acquisition deadline so that data can be acquired.

### Exemplary Embodiment 2

A description will now be given of exemplary embodiment 2. Like exemplary embodiment 1, exemplary embodiment 2 of the present disclosure relates to a communication system that performs wireless communication between a plurality of vehicles and a server. In exemplary embodiment 1, the communication system is used for OTA, but in exemplary embodiment 2, the communication system is used in applications other than OTA. For example, the communication system updates the vehicle's software or firmware that is not updated by OTA. To describe it specifically, the update data for updating the static information installed at the time of shipment of the vehicle 100 is generally large and so is not subject to OTA to suppress the communication cost. The communication system according to exemplary embodiment 2 distributes such update data. Since the communication system 1000 and the vehicle 100 according to exemplary embodiment 2 are of the same type as those of FIGS. 1 and 3, the differences from exemplary embodiment 1 will be described here mainly.

As described above, the second control apparatus 120 in FIG. 2 operates according to the software stored in the second storage unit 122, but the software stored in the second storage unit 122 is not subject to OTA. The software is static information installed at the time of shipment of the vehicle 100. On the other hand, the software stored in the second storage unit 122 is updated according to the shipment year of the vehicle 100, etc. Therefore, it is desirable that the software stored in the second storage unit 122 of the vehicle 100 shipped in the past is also updated.

It is assumed here that the software stored in the second storage unit 122 of the first vehicle 100a of FIG. 1 is a new version, and the software stored in the second storage unit 122 of the second vehicle 100b is an old version. Further, the updated part (update data) in the software of the new version is divided into the first data through the third data by way of one example. In other words, the second storage unit 122 of the first vehicle 100a retains the update data including the first data, the second data, and the third data. The number of divisions of the update data is not limited to “3”.

The server 200 stores information for verifying the legitimacy of each of the first data through the third data, i.e., information that ensures the tampering resistance of each data. For example, the server 200 stores the first information for verifying the legitimacy of the first data, the second information for verifying the legitimacy of the second data, and the third information for verifying the legitimacy of the third data. The first information is the first hash value, the second information is the second hash value, and the third information is the third hash value. The first hash value, the second hash value, and the third hash value are included in the management information.

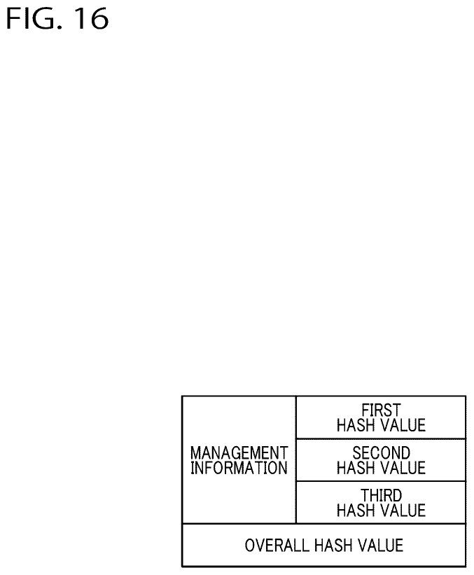

The server 200 transmits the management information to the second vehicle 100b. That is, the server 200 transmits the management information but does not transmit the update data. FIG. 16 shows a data format of the signal transmitted from the server 200. The management information includes the “first hash value”, the “second hash value”, and the “third hash value”. The overall hash value is the hash value for the management information. Reference is made back to FIG. 1.

The server communication unit 110 of the second vehicle 100b receives the management information from the server 200. The server communication unit 110 outputs the management information and the overall hash value to the first control apparatus 112. The verification unit 132 of the first control apparatus 112 receives the management information and the overall hash value from the server communication unit 110. The verification unit 132 verifies the legitimacy of the management information using the overall hash value. When the management information is legitimate, the first control apparatus 112 outputs the management information to the second control apparatus 120. Further, the first control apparatus 112 stores the management information in the first storage unit 114.

The second control apparatus 120 receives the management information from the first control apparatus 112. The second control apparatus 120 recognizes the existence of the update data based on the management information and requests the first control apparatus 112 to acquire the first data through the third data.

The ad hoc communication unit 116 communicates with other vehicles 100 (e.g., the first vehicle 100a, the third vehicle 100c) by vehicle-to-vehicle communication as already described. The ad hoc communication unit 116 receives the first data-related information from the first vehicle 100a. The first data-related information has the same data structure as in exemplary embodiment 1 but includes the number of divisions. The ad hoc communication unit 116 outputs the first data-related information to the first control apparatus 112. The verification unit 132 receives the first data-related information from the ad hoc communication unit 116. The verification unit 132 verifies the legitimacy of the first data by referring to the first hash value stored in the first storage unit 114. When the first data is legitimate, the first control apparatus 112 outputs the first data-related information to the second control apparatus 120.

When the second control apparatus 120 receives the first data-related information from the first control apparatus 112, the second control apparatus 120 causes the second storage unit 122 to store the first data-related information. The same process is performed for the second data-related information and the third data-related information. As a result, the second storage unit 122 stores the first data-related information through the third data-related information.

The second control apparatus 120 extracts the first data through the third data from the second storage unit 122 and acquires the update data by combining the first data through the third data. The second control apparatus 120 updates the software stored in the second storage unit 122 with the update data.

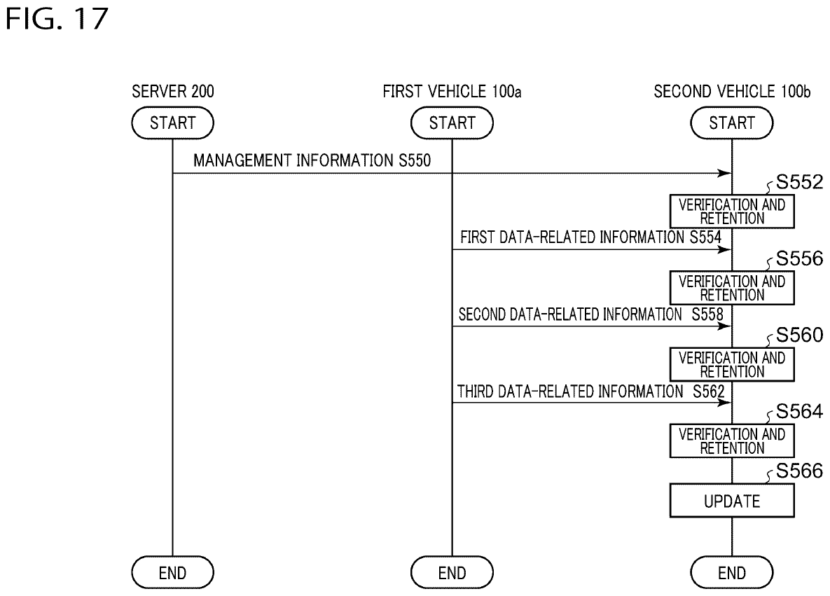

The operation of the communication system 1000 according to the above configuration will be described. FIG. 17 is a sequence chart showing the steps of communication performed by the communication system 1000. In the following, the overall hash value is omitted. The server 200 transmits the management information to the second vehicle 100b (S550). The second vehicle 100b performs verification and retention of the management information received (S552).

When the first vehicle 100a and the second vehicle 100b approach each other, the first vehicle 100a transmits the first data-related information to the second vehicle 100b (S554). The second vehicle 100b performs verification and retention of the first data-related information received (S556). When the first vehicle 100a and the second vehicle 100b approach each other, the first vehicle 100a transmits the second data-related information to the second vehicle 100b (S558). The second vehicle 100b performs verification and retention of the second data-related information received (S560).

When the first vehicle 100a and the second vehicle 100b approach each other, the first vehicle 100a transmits the third data-related information to the second vehicle 100b (S562). The second vehicle 100b performs verification and retention of the third data-related information received (S564). The second vehicle 100b aggregates the first data through the third data to form the update data and updates the software with the update data (S566).

For vehicle-to-vehicle communication in such a process and, in particular, vehicle-to-vehicle communication between the first vehicle 100a and the second vehicle 100b, and communication between the second vehicle 100b and the server 200, any of the above-described first through tenth processes may be used.

According to this exemplary embodiment, information for verifying the legitimacy of all divided data is transmitted, but the divided data is not transmitted so that the legitimacy of the data can be ensured while reducing the amount of communication from the server at the same time. In addition, the divided data is acquired by vehicle-to-vehicle communication so that data that is not subject to OTA can also be acquired.

A summary of an embodiment of the present disclosure is given below.

### (Item 1)

A communication system including:
a server that stores data including first data and second data, first information for verifying legitimacy of the first data, and second information for verifying legitimacy of the second data; and
a first vehicle and a second vehicle adapted to communicate with the server,
wherein the server transmits management information and the first data to the first vehicle and transmits the management information and the second data to the second vehicle, the management information including the first information and the second information,
wherein the first vehicle receives the management information and the first data from the server,
wherein the second vehicle receives the management information and the second data from the server,
wherein the first vehicle transmits the first data to the second vehicle, and
wherein the second vehicle receives the first data from the first vehicle and then verifies legitimacy of the first data by referring to the first information included in the management information.

According to this embodiment, one piece of divided data is transmitted, and information for verifying the legitimacy of all divided data is transmitted so that the legitimacy of the data can be ensured while reducing the amount of communication from the server at the same time.

### (Item 2)

A communication system including:
a first vehicle that retains data including first data and second data;
a server that stores first information for verifying legitimacy of the first data and second information for verifying legitimacy of the second data; and
a second vehicle adapted to communicate with the first vehicle and the server,
wherein the server transmits management information including the first information and the second information to the second vehicle,
wherein the second vehicle receives the management information from the server,
wherein the first vehicle transmits the first data to the second vehicle, and
wherein the second vehicle receives the first data from the first vehicle and then verifies legitimacy of the first data by referring to the first information included in the management information.

According to this embodiment, information for verifying the legitimacy of all divided data is transmitted, but the divided data is not transmitted so that the legitimacy of the data can be ensured while reducing the amount of communication from the server at the same time.

### (Item 3)

The communication system according to Item 1 or 2,
wherein the second vehicle requests the first vehicle to transmit the first data, and
wherein the first vehicle transmits the first data to the second vehicle in response to a request from the second vehicle.

In this case, the first vehicle transmits data in response to a request from the second vehicle so that the second vehicle can acquire data according to the request.

### (Item 4)

The communication system according to Item 1 or 2,
wherein the data also includes third data,
wherein the second vehicle selects, of the first data and the third data, the first data based on a speed of the second vehicle and requests the first vehicle to transmit the first data, and
wherein the first vehicle transmits the first data to the second vehicle in response to a request from the second vehicle.

In this case, in a situation where the first vehicle transmits data in response to a request from the second vehicle, data corresponding to the speed of the second vehicle is requested so that the size of the data can be increased while improving the success rate of communication at the same time.

### (Item 5)

The communication system according to Item 1 or 2,
wherein the data also includes third data,
wherein the second vehicle requests the first vehicle to transmit the first data and the third data, and
wherein the first vehicle transmits the first data to the second vehicle in response to a request from the second vehicle.

In this case, in a situation where the first vehicle transmits data in response to a request from the second vehicle, a plurality of pieces of data are requested so that a failure of the first vehicle to transmit data can be suppressed.

### (Item 6)

The communication system according to Item 1 or 2,
wherein the data also includes third data,
wherein the first vehicle also retains the third data,
wherein the second vehicle requests the first vehicle to transmit the first data and the third data, and
wherein the first vehicle selects, of the first data and the third data, the first data based on a speed of the first vehicle in response to a request from the second vehicle and transmits the first data selected to the second vehicle.

In this case, in a situation where the first vehicle transmits data in response to a request from the second vehicle, a plurality of pieces of data are requested, and data corresponding to the speed of the first vehicle is transmitted so that the size of the data can be increased while improving the success rate of communication at the same time.

### (Item 7)

The communication system according to Item 1 or 2,
wherein the data also includes third data,
wherein the management information includes third information for verifying legitimacy of the third data,
wherein the first vehicle also retains the third data,
wherein the second vehicle requests the first vehicle to transmit the data retained by the first vehicle,
wherein the first vehicle transmits the first data and the third data to the second vehicle in response to a request from the second vehicle,
wherein the second vehicle confirms whether the second vehicle retains the first data and the third data received from the first vehicle, and
wherein, when the third data is not retained, the second vehicle verifies legitimacy of the third data by referring to the third information included in the management information.

In this case, in a situation where the first vehicle transmits data in response to a request from the second vehicle, the transmission of data retained by the first vehicle is requested so that the request can be simplified.

### (Item 8)

The communication system according to Item 1 or 2,
wherein the data also includes third data,
wherein the first vehicle also retains the third data,
wherein the second vehicle requests the first vehicle to transmit the data retained by the first vehicle,
wherein the first vehicle selects, of the first data and the third data, the first data based on a speed of the first vehicle in response to a request from the second vehicle and transmits the first data selected to the second vehicle, and
wherein the second vehicle confirms whether the second vehicle retains the first data received from the first vehicle.

In this case, in a situation where the first vehicle transmits data in response to a request from the second vehicle, the transmission of data retained by the first vehicle is requested, and data corresponding to the speed of the first vehicle is transmitted so that the size of the data can be increased while improving the success rate of communication at the same time.

### (Item 9)

The communication system according to Item 1 or 2,
wherein the data also includes third data,
wherein the management information includes third information for verifying legitimacy of the third data,
wherein the first vehicle also retains the third data,
wherein the first vehicle transmits the first data and the third data to the second vehicle,
wherein the second vehicle confirms whether the second vehicle retains the first data and the third data received from the first vehicle, and
wherein, when the third data is not retained, the second vehicle verifies legitimacy of the third data by referring to the third information included in the management information.

In this case, the first vehicle transmits data even if there is no request from the second vehicle so that the communication steps can be simplified.

### (Item 10)

The communication system according to Item 1 or 2,
wherein the data also includes third data,
wherein the first vehicle also retains the third data,
wherein the first vehicle selects, of the first data and the third data, the first data based on a speed of the first vehicle and transmits the first data selected to the second vehicle, and
wherein the second vehicle confirms whether the second vehicle retains the first data received from the first vehicle.

In this case, in a situation where the first vehicle transmits data even if there is no request from the second vehicle, data corresponding to the speed of the first vehicle is transmitted so that the size of the data can be increased while improving the success rate of communication at the same time.

### (Item 11)

The communication system according to Item 1 or 2,
wherein the second vehicle receives the first data from the server when the second vehicle fails to acquire the first data by an acquisition deadline.

In this case, data is received from the server when data cannot be acquired by the acquisition deadline so that data can be acquired.

### (Item 12)

A communication method in a server and in a first vehicle and a second vehicle adapted to communicate with the server, the server storing data including first data and second data, first information for verifying legitimacy of the first data, and second information for verifying legitimacy of the second data, including:
transmitting, by the server, management information and the first data to the first vehicle and transmitting the management information and the second data to the second vehicle, the management information including the first information and the second information;
receiving, by the first vehicle, the management information and the first data from the server;
receiving, by the second vehicle, the management information and the second data from the server;
transmitting, by the first vehicle, the first data to the second vehicle, and
receiving, by the second vehicle, the first data from the first vehicle and then verifying legitimacy of the first data by referring to the first information included in the management information.

### (Item 13)

A communication method in a first vehicle, a second vehicle, and a server, the first vehicle retaining data including first data and second data, the server storing first information for verifying legitimacy of the first data and second information for verifying legitimacy of the second data, and the second vehicle being adapted to communicate with the first vehicle and the server, including:
transmitting, by the server, management information including the first information and the second information to the second vehicle;
receiving, by the second vehicle, the management information from the server;
transmitting, by the first vehicle, the first data to the second vehicle; and
receiving, by the second vehicle, the first data from the first vehicle and then verifying legitimacy of the first data by referring to the first information included in the management information.

### (Item 14)

A vehicle including:
a first communication unit that receives, from a server that stores data including first data and second data, first information for verifying legitimacy of the first data, and second information for verifying legitimacy of the second data, management information and the second data, the management information including the first information and the second information;
a second communication unit that receives the first data from a further vehicle that receives the management information and the first data from the server; and
a processing unit that verifies legitimacy of the first data received by the second communication unit by referring to the first information included in the management information received by the first communication unit.

### (Item 15)

A vehicle including:
a first communication unit that receives, from a server that stores first information for verifying legitimacy of first data and second information for verifying legitimacy of second data, management information including the first information and the second information;
a second communication unit that receives the first data from a further vehicle that stores data including the first data and the second data; and
a processing unit that verifies legitimacy of the first data received by the second communication unit by referring to the first information included in the management information received by the first communication unit.

The present disclosure has been described above based on an exemplary embodiment. The exemplary embodiment intended to be illustrative only and it will be understood by those skilled in the art that various modifications to combinations of constituting elements and processes are possible and that such modifications are also within the scope of the present disclosure.

The data (divided data) in exemplary embodiments 1 and 2 may not be limited to OTA data but may be containers. Alternatively, containers connected (semi-processed intermediate deliverable) may be delivered. Alternatively, the data may be binary partitions of a trained AI model. Alternatively, the management information may be a variable-length array (a set of a parameter and a corresponding value as in json) or a non-variable-length array (a predetermined size). According to this variation, the flexibility of the configuration can be improved.

While various embodiments have been described herein above, it is to be appreciated that various changes in form and detail may be made without departing from the spirit and scope of the invention(s) presently or hereafter claimed.

### CROSS-REFERENCE TO RELATED APPLICATION

This application is based upon and claims the benefit of priority from the prior Japanese Patent Application No. 2024-105679, filed on Jun. 28, 2024, the entire contents of which are incorporated herein by reference.

What is claimed is:

1. A communication system comprising:
a server that stores data including first data and second data, first information for verifying legitimacy of the first data, and second information for verifying legitimacy of the second data; and
a first vehicle and a second vehicle adapted to communicate with the server,
wherein the server transmits management information and the first data to the first vehicle and transmits the management information and the second data to the second vehicle, the management information including the first information and the second information,
wherein the first vehicle receives the management information and the first data from the server,
wherein the second vehicle receives the management information and the second data from the server,
wherein the first vehicle transmits the first data to the second vehicle, and
wherein the second vehicle receives the first data from the first vehicle and then verifies legitimacy of the first data by referring to the first information included in the management information.

2. The communication system according to claim 1,
wherein the second vehicle requests the first vehicle to transmit the first data, and
wherein the first vehicle transmits the first data to the second vehicle in response to a request from the second vehicle.

3. The communication system according to claim 1,
wherein the data also includes third data,
wherein the second vehicle selects, of the first data and the third data, the first data based on a speed of the second vehicle and requests the first vehicle to transmit the first data, and
wherein the first vehicle transmits the first data to the second vehicle in response to a request from the second vehicle.

4. The communication system according to claim 1,
wherein the data also includes third data,
wherein the second vehicle requests the first vehicle to transmit the first data and the third data, and
wherein the first vehicle transmits the first data to the second vehicle in response to a request from the second vehicle.

5. The communication system according to claim 1,
wherein the data also includes third data,
wherein the first vehicle also retains the third data,
wherein the second vehicle requests the first vehicle to transmit the first data and the third data, and
wherein the first vehicle selects, of the first data and the third data, the first data based on a speed of the first vehicle in response to a request from the second vehicle and transmits the first data selected to the second vehicle.

6. The communication system according to claim 1,
wherein the data also includes third data,
wherein the management information includes third information for verifying legitimacy of the third data,
wherein the first vehicle also retains the third data,
wherein the second vehicle requests the first vehicle to transmit the data retained by the first vehicle,
wherein the first vehicle transmits the first data and the third data to the second vehicle in response to a request from the second vehicle,
wherein the second vehicle confirms whether the second vehicle retains the first data and the third data received from the first vehicle, and
wherein, when the third data is not retained, the second vehicle verifies legitimacy of the third data by referring to the third information included in the management information.

7. The communication system according to claim 1,
wherein the data also includes third data,
wherein the first vehicle also retains the third data,
wherein the second vehicle requests the first vehicle to transmit the data retained by the first vehicle,
wherein the first vehicle selects, of the first data and the third data, the first data based on a speed of the first vehicle in response to a request from the second vehicle and transmits the first data selected to the second vehicle, and
wherein the second vehicle confirms whether the second vehicle retains the first data received from the first vehicle.

8. The communication system according to claim 1,
wherein the data also includes third data,
wherein the management information includes third information for verifying legitimacy of the third data,
wherein the first vehicle also retains the third data,
wherein the first vehicle transmits the first data and the third data to the second vehicle,
wherein the second vehicle confirms whether the second vehicle retains the first data and the third data received from the first vehicle, and
wherein, when the third data is not retained, the second vehicle verifies legitimacy of the third data by referring to the third information included in the management information.

9. The communication system according to claim 1,
wherein the data also includes third data,
wherein the first vehicle also retains the third data,
wherein the first vehicle selects, of the first data and the third data, the first data based on a speed of the first vehicle and transmits the first data selected to the second vehicle, and
wherein the second vehicle confirms whether the second vehicle retains the first data received from the first vehicle.

10. The communication system according to claim 1,
wherein the second vehicle receives the first data from the server when the second vehicle fails to acquire the first data by an acquisition deadline.

11. A communication system comprising:
a first vehicle that retains data including first data and second data;
a server that stores first information for verifying legitimacy of the first data and second information for verifying legitimacy of the second data; and
a second vehicle adapted to communicate with the first vehicle and the server,
wherein the server transmits management information including the first information and the second information to the second vehicle,
wherein the second vehicle receives the management information from the server,
wherein the first vehicle transmits the first data to the second vehicle, and
wherein the second vehicle receives the first data from the first vehicle and then verifies legitimacy of the first data by referring to the first information included in the management information.

12. The communication system according to claim 11,
wherein the second vehicle requests the first vehicle to transmit the first data, and
wherein the first vehicle transmits the first data to the second vehicle in response to a request from the second vehicle.

13. The communication system according to claim 11,
wherein the data also includes third data,
wherein the second vehicle selects, of the first data and the third data, the first data based on a speed of the second vehicle and requests the first vehicle to transmit the first data, and
wherein the first vehicle transmits the first data to the second vehicle in response to a request from the second vehicle.

14. The communication system according to claim 11,
wherein the data also includes third data,
wherein the second vehicle requests the first vehicle to transmit the first data and the third data, and
wherein the first vehicle transmits the first data to the second vehicle in response to a request from the second vehicle.

15. The communication system according to claim 11,
wherein the data also includes third data,
wherein the first vehicle also retains the third data,
wherein the second vehicle requests the first vehicle to transmit the first data and the third data, and
wherein the first vehicle selects, of the first data and the third data, the first data based on a speed of the first vehicle in response to a request from the second vehicle and transmits the first data selected to the second vehicle.

16. The communication system according to claim 11,
wherein the data also includes third data,
wherein the management information includes third information for verifying legitimacy of the third data,
wherein the first vehicle also retains the third data,
wherein the second vehicle requests the first vehicle to transmit the data retained by the first vehicle,
wherein the first vehicle transmits the first data and the third data to the second vehicle in response to a request from the second vehicle,
wherein the second vehicle confirms whether the second vehicle retains the first data and the third data received from the first vehicle, and
wherein, when the third data is not retained, the second vehicle verifies legitimacy of the third data by referring to the third information included in the management information.

17. The communication system according to claim 11,
wherein the data also includes third data,
wherein the first vehicle also retains the third data,
wherein the second vehicle requests the first vehicle to transmit the data retained by the first vehicle,
wherein the first vehicle selects, of the first data and the third data, the first data based on a speed of the first vehicle in response to a request from the second vehicle and transmits the first data selected to the second vehicle, and
wherein the second vehicle confirms whether the second vehicle retains the first data received from the first vehicle.

18. The communication system according to claim 11,
wherein the data also includes third data,
wherein the management information includes third information for verifying legitimacy of the third data,
wherein the first vehicle also retains the third data,
wherein the first vehicle transmits the first data and the third data to the second vehicle,
wherein the second vehicle confirms whether the second vehicle retains the first data and the third data received from the first vehicle, and
wherein, when the third data is not retained, the second vehicle verifies legitimacy of the third data by referring to the third information included in the management information.

19. The communication system according to claim 11,
wherein the data also includes third data,
wherein the first vehicle also retains the third data,
wherein the first vehicle selects, of the first data and the third data, the first data based on a speed of the first vehicle and transmits the first data selected to the second vehicle, and
wherein the second vehicle confirms whether the second vehicle retains the first data received from the first vehicle.

20. The communication system according to claim 11,
wherein the second vehicle receives the first data from the server when the second vehicle fails to acquire the first data by an acquisition deadline.
